(19) United States
(12) Patent Application Publication
(10) Pub. No.: US 2012/0044122 A1
(43) Pub. Date: Feb. 23, 2012

(54) BROADBAND ANTENNA USING AN ELECTRIC LOOP-TYPE SIGNAL LINE

(75) Inventors: Sung-Nam An, Seoul (KR); Bo-Sung Kwon, Seoul (KR); Hae-Yeon Kim, Gyeonggi-do (KR); Jae-Ho Lee, Gyeongsangbuk-do (KR); Byong-Nam Kim, Kyeonggi-do (KR)

(73) Assignee: ACE TECHNOLOGIES CORPORATION, Incheon-si (KR)

(21) Appl. No.: 13/266,435

(22) PCT Filed: Apr. 27, 2010
(86) PCT No.: PCT/KR2010/002657

§ 371 Date: Oct. 26, 2011

(30) Foreign Application Priority Data
Apr. 27, 2009 (KR) 10-2009-0036502

(51) Int. Cl. H01Q 1/50

(52) U.S. Cl. 343/862

(57) ABSTRACT

A broadband antenna is disclosed. The disclosed antenna may include: a substrate; an impedance matching/feeding unit, arranged on the substrate and comprising a first matching member and a second matching member configured to perform impedance matching through a coupling method; a radiating member electrically connected to the impedance matching/feeding unit; and a signal line electrically connected to the second matching member. Here, the signal line is implemented in the form of an electrical loop.

### TECHNICAL FIELD

The present invention relates to an antenna, more particularly to a broadband antenna using an electric loop-type signal line.

### BACKGROUND ART

Recently there has been a demand for multiple-band service, for servicing many frequency bands. There is a demand for mobile communication terminals that are able to provide services using a variety of frequency bands such as, for example, the CDMA service of the 824-894 MHz band and the PCS service of the 1750-1870 MHz, which have been commercialized in Korea, the CDMA service of the 832-925 MHz band, which has been commercialized in Japan, the PCS service of the 1850-1990 MHz band, which has been commercialized in the U.S., the GSM service of the 880-960 MHz band, which has been commercialized in Europe and China, and the DCS service of the 1710-1880 MHz band, which has been commercialized in parts of Europe. Besides these, there is also a demand for composite terminals that are able to use services such as Bluetooth, ZigBee, wireless LAN, GPS, etc.

In order to support such multiple-band services, the mobile communication terminal should be equipped with a multiple band antenna that is able to operate in the aforementioned frequency bands. In general, for an antenna for supporting the multiple-band services, a helical antenna and a planar inverted-F antenna (PIFA) are mainly used.

The helical antenna is an external antenna affixed to the top end of a terminal, and is used together with a monopole antenna. Here, a helical and monopole antenna in combined usage is such that if the antenna is extended out of the body of the terminal, it acts as a monopole antenna, and if it is retracted, it acts as a λ/4 helical antenna.

Such an antenna has the advantage of high profits, but due to its non-directivity, the SAR (specific absorption rate)—the standard for the level of harmfulness of electromagnetic waves to the human body—is not good. Also, as a helical antenna is constructed as protruding out of a terminal, it is not easy to provide an esthetic appearance and an external design suitable to portability of the terminal.

The inverted-F antenna is an antenna designed with a low profile structure for the purpose of overcoming such disadvantages. More specifically, in the inverted-F antenna, from among the beams radiated from the radiator, the beams outputted toward the grounding surface are re-directed by the grounding surface toward the radiator. Consequently, the beams emitted toward the human body may be reduced, and accordingly its SAR is improved. Also, as the beams are re-directed from the grounding surface toward the radiator, the directivity of the beams outward from the radiator may be improved. Consequently, the length of the rectangular flat-board radiator may be reduced in half, and accordingly, it may be implemented with a low profile structure, operating as a rectangular micro-strip antenna.

However, while the inverted-F antenna has the advantage of improved directivity, it entails the problem of having a narrow frequency band.

Thus, there is a demand for an antenna that is able to overcome the disadvantage of narrow band characteristics of the inverted-F antenna while having a low profile structure for a more stable operation in multiple bands.

### DISCLOSURE

### Technical Problem

The purpose of the present invention is to provide an antenna having broadband characteristics through a impedance matching/feeding unit that utilizes a coupling method.

Another purpose of the present invention is to provide an antenna that has broadband characteristics and improves impedance matching in low frequency bands and high frequency bands by implementing the signal line in the form of an electrical loop and with a sufficient area.

### Technical Solution

To achieve the objectives above, an embodiment of the invention provides a broadband antenna that includes a substrate; an impedance matching/feeding unit, arranged on the substrate and comprising a first matching member and a second matching member configured to perform impedance matching through a coupling method; a radiating member electrically connected to the impedance matching/feeding unit; and a signal line electrically connected to the second matching member. Here, the signal line has a form of an electrical loop.

The first matching member is electrically connected to the ground, and the impedance matching/feeding unit provides coupling to the signal line.

The signal line comprises a first signal part arranged parallel to the second matching member, the second member provides coupling to the first signal part; a second signal part perpendicular to the second matching member, the impedance matching/feeding unit provides coupling to the second signal part; and a third signal part electrically connected to the second signal part, the third signal part having a designated length, wherein the signal line generates dual resonance in high-frequency bands.

The antenna further comprises at least one first protruding part protruding from the first matching member; and at least one second protruding part protruding from the second matching member. Here, the first protruding parts and the second protruding parts are separated from one another, and some of the first protruding parts and the second protruding parts are separated by different distances.

At least one of the first matching member and the second matching member has a bent structure.

Another embodiment of the invention provides a broadband antenna that includes a substrate; an impedance matching/feeding unit, arranged on the substrate and comprising a first matching member and a second matching member configured to perform impedance matching through a coupling method; a radiating member electrically connected to the impedance matching/feeding unit; and a signal line electrically connected to the second matching member. Here, the signal line further comprises a first signal part, electrically connected to the second matching member; and a second signal part, electrically connected to the first signal part, and oriented in a direction that intersects with the second matching member.

The signal line further comprises a third signal part, the third signal part electrically connected to the second signal part and having a designated length, wherein the second matching member provides coupling to the first signal part, the impedance matching/feeding part provides coupling to the second signal part, and the signal line has a form of an electrical loop and generates dual resonance in high-frequency bands.

The antenna further comprises at least one first protruding part, protruding from the first matching member; and at least one second protruding part, protruding from the second matching member. Here, the first protruding parts and the second protruding parts are separated from one another, and some of the first protruding parts and the second protruding parts are separated by different distances.

The distance between the first matching member and the second matching member is partially different.

At least one of the first matching member and the second matching member has a bent structure.

The radiating member extends from the first matching member, and is fed from the second matching member through a coupling method.

### Advantageous Effects

A broadband antenna according to the present invention has the advantage of broadband characteristics by way of coupling matching using an impedance matching/feeding unit.

Also, the matching members of the impedance matching/feeding unit of an antenna according to the present invention have protruding parts, thus not only increasing capacitance but also diversifying it. Consequently, the antenna may be less affected by external factors such as hand effects.

Furthermore, since the signal line electrically connected to the impedance matching/feeding unit of the antenna has a sufficient area and is in the form of an electrical loop, the antenna provides the advantages of improving impedance matching in high-frequency and low-frequency bands and achieving broadband.

### DESCRIPTION OF DRAWINGS

FIG. 1 is a drawing illustrating a broadband antenna according to an embodiment of the present invention.

FIG. 2 is a drawing illustrating various structures of protruding parts according to an embodiment of the present invention.

FIG. 3 is a drawing illustrating impedance matching and frequency band characteristics of an antenna according to a first embodiment of the present invention.

FIG. 4 is a drawing illustrating impedance matching and frequency band characteristics of an antenna according to a second embodiment of the present invention.

FIG. 5 is a drawing illustrating impedance matching and frequency band characteristics of an antenna according to a third embodiment of the present invention.

FIG. 6 is a drawing illustrating impedance matching and frequency band characteristics of an antenna according to a fourth embodiment of the present invention.

FIG. 7 is a drawing illustrating impedance matching and frequency band characteristics of an antenna according to a fifth embodiment of the present invention.

FIG. 8 is a drawing illustrating a broadband antenna according to a second embodiment of the present invention.

### MODE FOR INVENTION

As the present invention allows for various changes and numerous embodiments, particular embodiments will be illustrated in the drawings and described in detail. However, this is not intended to limit the present invention to particular modes of practice, and it is to be appreciated that all changes, equivalents, and substitutes that do not depart from the spirit and technical scope of the present invention are encompassed in the present invention. In describing the drawings, those components that are the same or are in correspondence are rendered the same reference numeral.

When a component is described as “connected” or “joined” to another component, it is to be appreciated that the two components can be directly connected or directly joined to each other but can also include one or more other components in-between. On the other hand, when a component is described as “directly connected” or “directly joined” to another component, it is to be appreciated that there is no other component in-between.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical and scientific terms, have the same meanings as the terms generally understood by those having ordinary skill in the technical field to which the present invention belongs. Terms having the same meanings as defined in generally used dictionaries should be interpreted as having the meanings corresponding to those used in the context of the related art, and are not to be interpreted as having idealistic or overly formalistic meanings, unless clearly defined in the present specification.

Embodiments of the present invention will be described below in more detail with reference to the accompanying drawings.

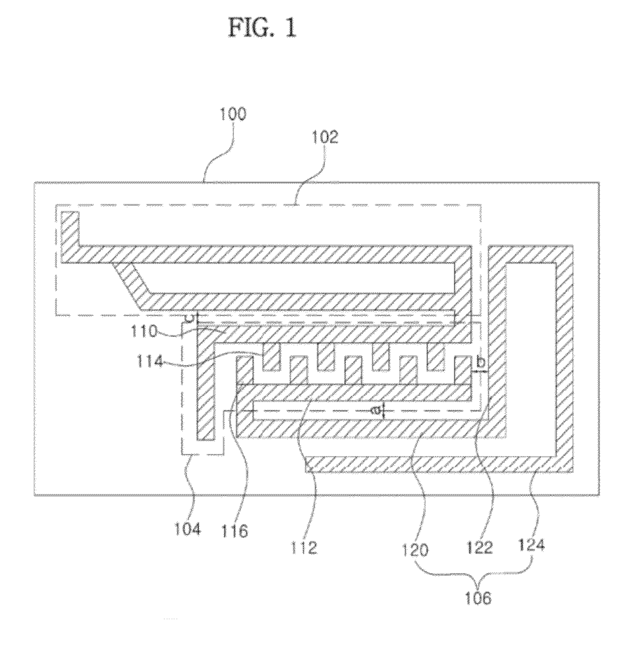

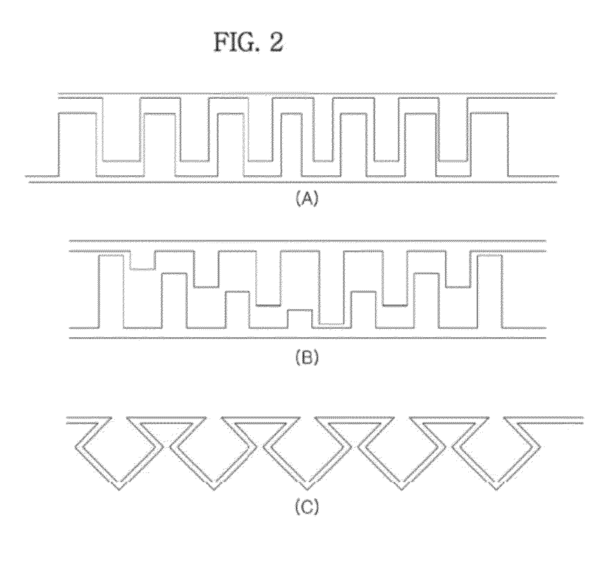

FIG. 1 is a drawing illustrating a broadband antenna according to an embodiment of the present invention, and FIG. 2 is a drawing illustrating various structures of protruding parts according to an embodiment of the present invention.

An antenna according to an embodiment of the present invention can be an antenna having a broadband to service multiple bands, can be installed, for instance, inside a mobile communication terminal, and can support such service bands as GSM, WCDMA, etc. In particular, the antenna can improve impedance matching in low-frequency bands and high-frequency bands, and can have broadband characteristics in the high-frequency bands, as will be described below.

Referring to FIG. 1, an antenna according to the embodiment comprises a substrate 100, a radiating member 102, an impedance matching/feeding unit 104, and a signal line 106.

The substrate 100 is made of dielectric material having a designated dielectric constant.

The radiating member 102 is electrically connected to the impedance matching/feeding unit 104, and outputs a specific radiating pattern when a designated amount of electric power is fed through the impedance matching/feeding unit 104. However, the radiating member 102 is not limited to the structure in FIG. 1, and may be modified in a variety of ways with no particular limitations, as long as it is electrically connected to the impedance matching/feeding unit 104. For instance, the radiating member may have the kind of structure enabling multiple bands in and of itself.

The impedance matching/feeding unit 104 increases frequency band by means of a coupling method, in order to solve the problem of the inverted-F antenna having a narrow frequency band.

This impedance matching/feeding unit 104 is arranged on the substrate 100, and comprises a first matching member 110 electrically connected to the ground, a second matching member 112 electrically connected to the signal line 106, at least one first protruding part 114 and at least one second protruding part 116.

The first matching member 110 is fed from the second matching unit 112 through the coupling method. Here, as the radiating member 102 is electrically connected to the first matching member 110, the fed electrical power is transferred to the radiating member 102 through the coupling, and consequently a specific radiating pattern is outputted from the radiating member 102.

The second matching member 112 is electrically connected to the signal line 106, and provides RF signals (electrical power) transmitted from the signal line 106 to the radiating member 102 through the first matching member 110.

The first protruding parts 114 protrude from the first matching member 110, and the second protruding parts 116 protrude from the second matching member 112.

Because of these protruding parts 114 and 116, the distance between the matching units 110 and 112 actually becomes less, and consequently, it becomes possible to obtain a greater capacitance than when there are no protruding parts 114 and 116. Accordingly, a mobile communication terminal using the antenna may be less affected by such external factors as hand effect, etc.

According to an embodiment of the present invention, the distances between the first protruding parts 114 and between the second protruding parts 116 may be the same, but, as illustrated in FIG. 2, some may be separated at different distances. When some of the distances are different, the capacitances between matching members 110 and 112 may become different in different parts. In other words, the capacitance of the impedance matching/feeding unit 104 becomes diversified, and consequently, broadband matching may become possible.

According to another embodiment of the present invention, it may be that the protruding parts 114 and 116 do not protrude from the respective matching members 110 and 112; it may be that the first protruding parts 114 do protrude from the first matching member 110 while the second protruding parts 116 do not protrude from the second matching member 112. Of course, it may be that, conversely, the second protruding parts 116 do protrude from the second matching member 112 while the first protruding parts 114 do not protrude from the first matching member 110.

According to yet another embodiment of the present invention, as illustrated in FIG. 2(A), the widths of some of the protruding parts 114 and 116 may be different, or as illustrated in FIG. 2(B), the lengths of some of the protruding parts 114 and 116 may be different. Consequently, with the partial differences in the distances between the protruding parts 114 and 116, the capacitance of the impedance matching/feeding unit 104 may be diversified. Of course, this kind of diversification may be implemented in such a way that all the second protruding parts 116 are of the same length, but some of the first protruding parts 114 are of different lengths.

According to yet another embodiment of the present invention, as illustrated in FIG. 2(C), the protruding parts 114 and 116 may be of shapes other than rectangular.

In other words, the structure of the impedance matching/feeding unit 104 may be modified in a variety of ways, insofar as the coupling method is used to diversify capacitance.

Examining the structure of the impedance matching/feeding unit 104 described above from the point of view of matching, the first matching member 110 and the second matching member 112 perform coupling impedance matching through interaction. Here, when the first matching member 110 and the second matching member interact, capacitance rather than inductance works as the main factor for the coupling impedance matching. Since obtaining a greater capacitance is more advantageous, the protruding parts 114 and 116 are thus utilized as illustrated in FIG. 1.

The radiating member 102 is electrically connected to the first matching member 110 as mentioned above. Also, coupling occurs between the radiating member 102 and the first matching member 110, and accordingly, the distance c between the radiating member 102 and the first matching member 110 is important in determining the coupling amount. Here, the antenna's frequency band may be set by the length of the radiating member 102 and the length of the impedance matching/feeding unit 104.

The signal line 106 is electrically connected to the second matching member 112, and is implemented as an electrical loop, as illustrated in FIG. 1, for instance. Specifically, as one end of the signal line 106 is connected to the second matching member 112, and the first matching member 110 is connected to the ground, one end of the signal line 106 is electrically connected to the ground through the coupling of the matching members 110 and 112. Also, as the other end of the signal line 106 is connected to the feeding point, the ground and the feeding point are electrically connected by the signal line 106. In other words, the signal line 106 is implemented in the form of an electrical loop.

This signal line 106 comprises a first signal part 120, a second signal part 122, and a third signal part 124.

The first signal part 120 is electrically connected to the second matching member 112, and is arranged parallel to the second matching member 112, as illustrated in FIG. 1, for instance. Here, coupling occurs between the first signal part 120 and the second matching member 112, and accordingly, the distance c between the first signal part 120 and the second matching member 112 is important in determining the amount of coupling.

The second signal part 122 is electrically connected to the first signal part 120, in a direction perpendicular to the second matching member 112 for instance, and coupling occurs with the impedance matching/feeding unit 102. Accordingly, the distance c between the second signal part 122 and the impedance matching/feeding unit 102 is important in determining the amount of coupling.

The third signal part 124 is electrically connected to the second signal part 122, and is electrically connected to the feeding point.

In short, an antenna according to the present embodiment provides multiple bands and broadband, and diversifies capacitance by means of the impedance matching/feeding unit 104 that uses the coupling method.

Also, the signal line 106 has the form of an electrical loop as illustrated in FIG. 1, thus improving impedance matching in low-frequency bands and high-frequency bands and providing broadband characteristics in high-frequency bands, as will be described below.

Although not mentioned above, not only is the length of a signal line 106 important, but its width is also important, when implementing broadband and impedance matching. The length and width of such a signal line 106 will be determined by the band and impedance characteristics of the antenna to be implemented.

Below, impedance matching and bandwidth characteristics of an antenna according to the present embodiment will be described with reference to the accompanying drawings.

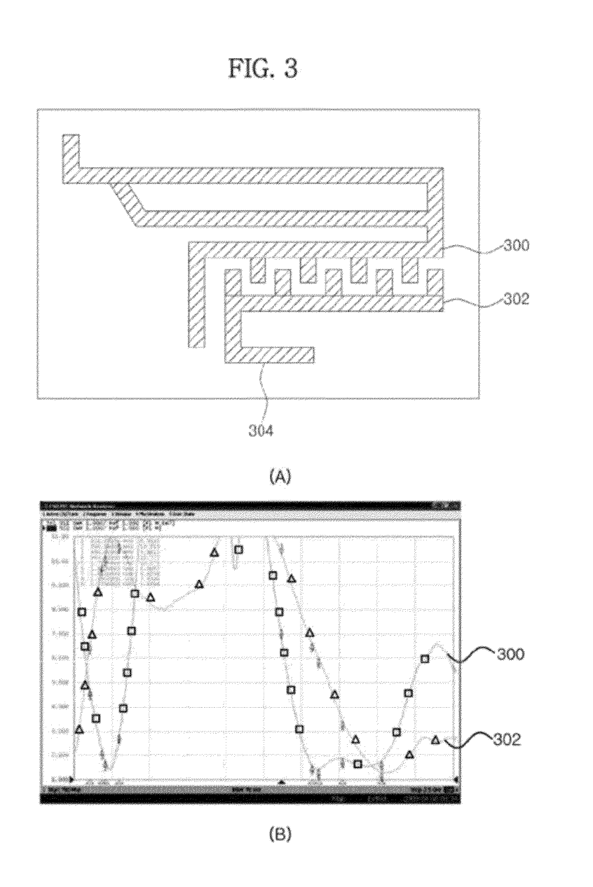

FIG. 3 is a drawing illustrating impedance matching and frequency band characteristics of an antenna according to a first embodiment of the present invention.

Unlike an antenna of the present invention, the first antenna illustrated in FIG. 3(A) has a signal line 304 directly connected to the second matching member 302.

Examining the S11 characteristic curve 302 of this first antenna and the S11 characteristic curve 300 of an antenna according to the present embodiment illustrated in FIG. 1, it may be confirmed that the antenna according to the present embodiment has impedance matching characteristics in low-frequency bands and high-frequency bands that are superior to those of the first antenna, as illustrated in FIG. 3(B). Also, examining the high-frequency bands, it may be confirmed that dual resonance occurs in the antenna according to the present embodiment, and thus the bandwidth is wider.

In other words, an antenna according to the present embodiment obtains a sufficient area (length and width) by implementing a signal line 106 as an electrical loop, thus improving impedance matching characteristics in low-frequency bands and high-frequency bands, and implementing broadband in high-frequency bands.

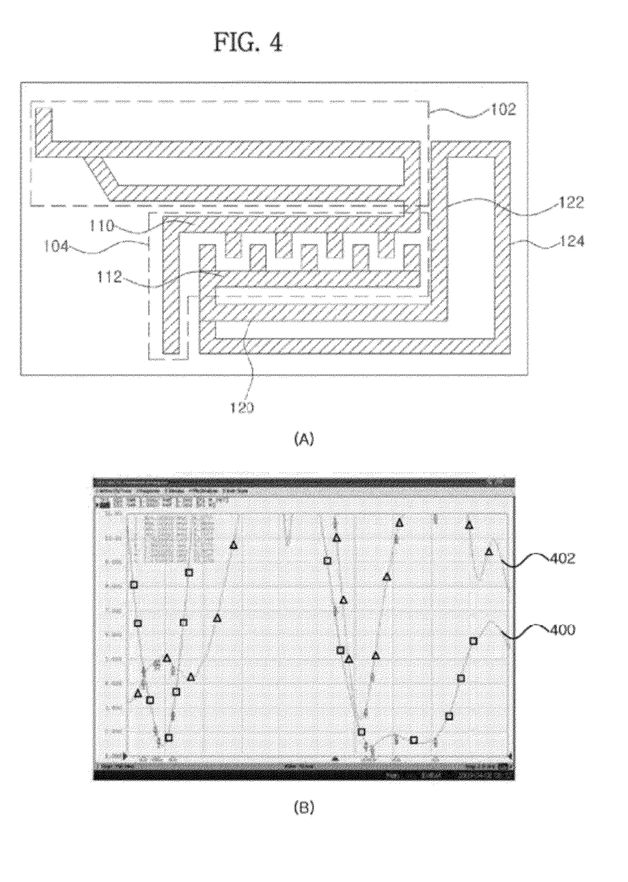

FIG. 4 is a drawing illustrating impedance matching and frequency band characteristics of an antenna according to a second embodiment of the present invention.

In the signal line 106 of the second antenna illustrated in FIG. 4(A), one end of the third signal part 124 is directly connected to the first signal part 120.

Examining the characteristic curve 402 of this second antenna and the S11 characteristic curve 400 of the antenna illustrated in FIG. 1, it may be confirmed that the antenna in FIG. 1 has impedance matching characteristics in low-frequency bands and high-frequency bands that are superior to those of the second antenna, as illustrated in FIG. 4(B). This is because the Q value increases with the concentration of energy in certain frequency bands, as the signal line 106 is implemented as an electrical loop.

Also, examining the high-frequency bands, it may be confirmed that dual resonance occurs in the antenna according to the present embodiment, and thus the bandwidth is wider.

In other words, an antenna according to the present embodiment has superior impedance matching characteristics and bandwidth characteristics.

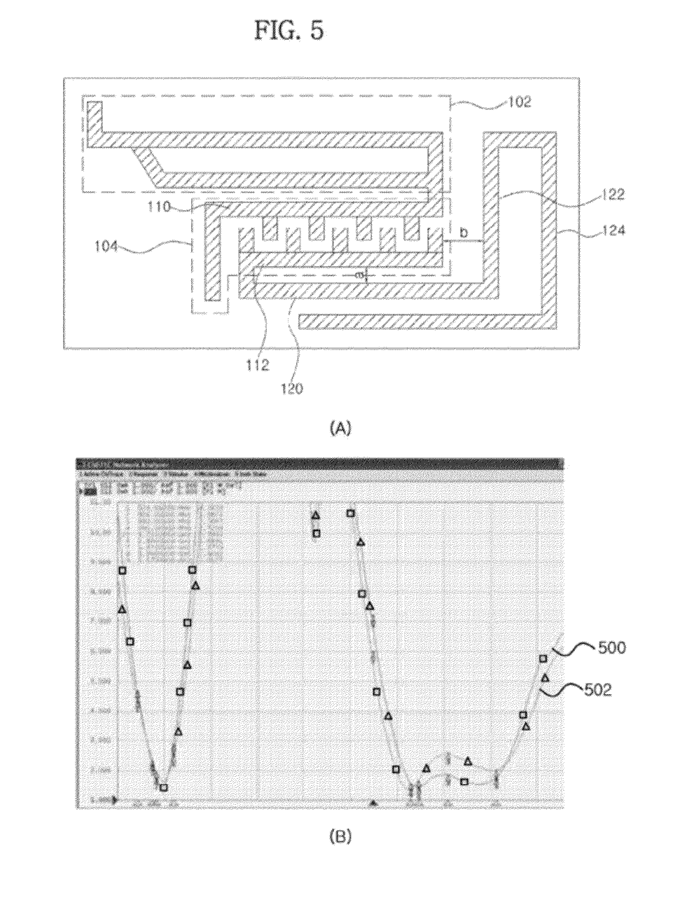

FIG. 5 is a drawing illustrating impedance matching and frequency band characteristics of an antenna according to a third embodiment of the present invention.

The third antenna illustrated in FIG. 5(A) is a modified example of an antenna of the present invention, in which the distance b between the impedance matching/feeding unit 104 and the second signal part 122 is greater than that of the antenna in FIG. 1.

In this case, examining the characteristic curve 502 of the third antenna and the S11 characteristic curve 500 of the antenna illustrated in FIG. 1, it may be confirmed that the antenna in FIG. 1 has impedance matching characteristics in high-frequency bands that are superior to those of the third antenna, as illustrated in FIG. 5(B). This is because the distance between the impedance matching/feeding unit 104 and the second signal part 122 in the antenna in FIG. 1 is smaller than that of the third antenna, and thus a greater coupling amount is fed to the impedance matching/feeding unit 104.

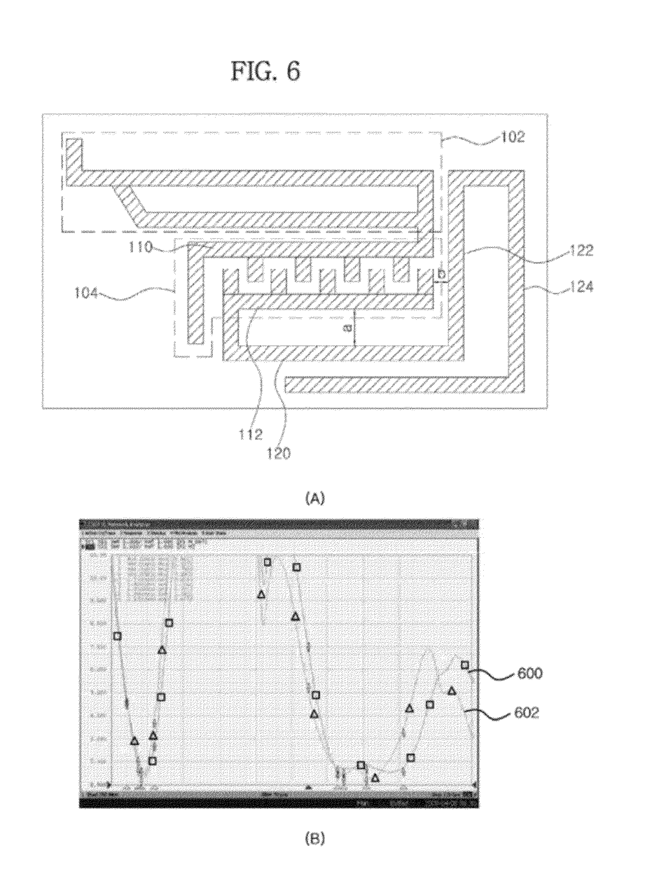

FIG. 6 is a drawing illustrating impedance matching and frequency band characteristics of an antenna according to a fourth embodiment of the present invention.

The fourth antenna illustrated in FIG. 6(A) is a modified example of an antenna of the present invention, in which the distance a between the second matching member 112 and the first signal part 120 is greater than that of the antenna in FIG. 1.

In this case, examining the characteristic curve 602 of the fourth antenna and the S11 characteristic curve 600 of the antenna illustrated in FIG. 1, it may be confirmed that the antenna in FIG. 1 implements a greater broadband in high-frequency bands than the fourth antenna, as illustrated in FIG. 6(B). This is because the distance between the second matching member 112 and the second signal part 122 in the antenna in FIG. 1 is smaller than that of the fourth antenna, and thus a greater coupling amount is fed to the impedance matching/feeding unit 104.

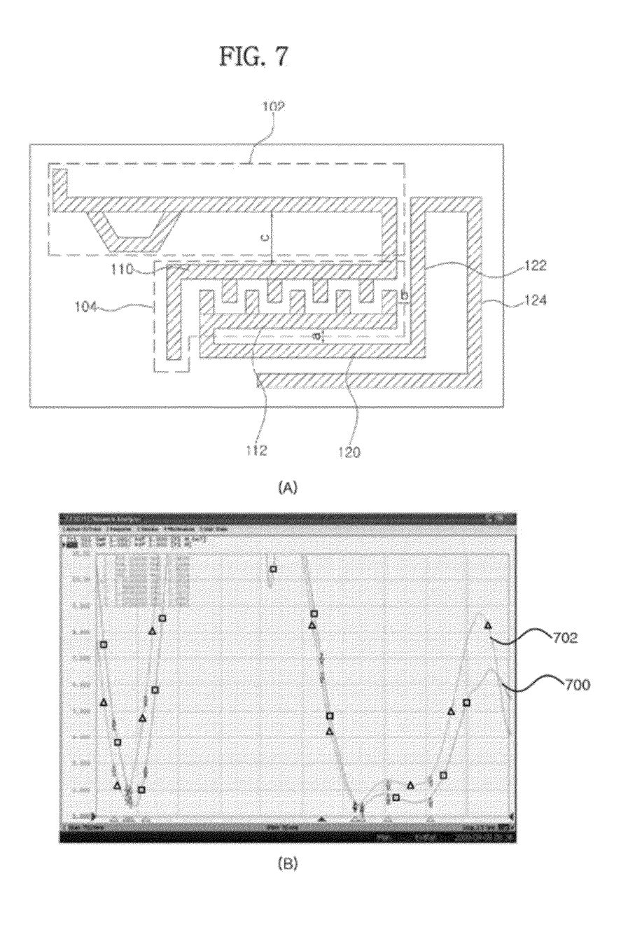

FIG. 7 is a drawing illustrating impedance matching and frequency band characteristics of an antenna according to a fifth embodiment of the present invention.

The fifth antenna in FIG. 7(A) is a modified example of an antenna of the present invention, in which the distance c between the first matching member 110 and the radiating member 102 is greater than that of the antenna in FIG. 1.

In this case, examining the characteristic curve 702 of the fifth antenna and the S11 characteristic curve 700 of the antenna illustrated in FIG. 1, it may be confirmed that the antenna in FIG. 1 improves impedance matching and implements greater broadband in high-frequency bands than the fifth antenna, as illustrated in FIG. 7(B). This is because the distance between the first matching member 110 and the radiating member 102 in the antenna in FIG. 1 is smaller than that of the fifth antenna, and thus a greater coupling amount is fed to the radiating member 102.

In short, examining the embodiments above shows that impedance matching is improved in low-frequency bands and high-frequency bands, and a greater broadband is implemented in high-frequency bands, as setting the distances a, b, and c to smaller values increases the coupling amount.

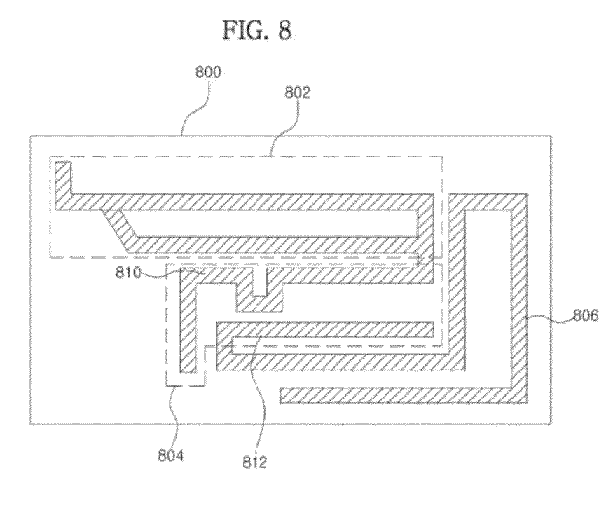

FIG. 8 is a drawing illustrating a broadband antenna according to a second embodiment of the present invention.

Referring to FIG. 8, a broadband antenna according to the present embodiment comprises a substrate 800, a radiating member 802, an impedance matching/feeding unit 804, and a signal line 806.

Since, except for the impedance matching/feeding unit 804, the other components are identical to those in the first embodiment, their descriptions will be foregone.

The first matching member 810 and the second matching member 812 of the impedance matching/feeding unit 804 do not have protruding parts. However, a part of the first matching member 810 is bent, and the second matching member 812 also is bent, in correspondence with the first matching member 810. Consequently, the distance between the first matching member 810 and the second matching member 812 is not consistent, and accordingly, diversification of capacitance becomes possible.

Above, each of the matching members 810 and 812 had one bent part, but there may also be two or more bent parts. In other words, the bent structures of the matching members 810 and 812 of the impedance matching/feeding unit 804 may be modified in a variety of ways, with no particular limitations.

According to another embodiment of the present invention, the structure of the impedance matching/feeding unit 804 may be designed differently, in order to set some of the distances between the first matching member 810 and the second matching member 812 differently. For instance, the second matching member 812 may be arranged at an angle in relation to the first matching member 810.

As described above, an antenna according to an embodiment of the present invention diversifies capacitance by various means such as bending either or both of the matching members 810 and 812 of the impedance matching/feeding unit 804, and arranging them at an angle. Preferably, the impedance matching/feeding unit 804 may be implemented in such a manner that the antenna has great capacitance.

Although not illustrated above, the antennas of the first embodiment and the second embodiment may further comprise a second radiating member besides a first radiating member electrically connected to a first matching member.

The second radiating member may be directly connected to a signal line, or may be fed from the signal line by the coupling method while being electrically connected to the ground.

The embodiments above are for illustrative purposes only and do not limit the invention. It is to be appreciated that those skilled in the art can change, modify, or add to the embodiments without departing from the scope and spirit of the invention. Such changes, modifications, and additions should be viewed as belonging to the scope of the invention as defined by the appended claims.

1. A broadband antenna comprising:
a substrate;
an impedance matching/feeding unit arranged on the substrate, the impedance matching/feeding unit comprising a first matching member and a second matching member configured to perform impedance matching through a coupling method;
a radiating member electrically connected to the impedance matching/feeding unit; and
a signal line electrically connected to the second matching member,
wherein the signal line has a form of an electrical loop.

2. The broadband antenna according to claim 1, wherein the first matching member is electrically connected to a ground, and the impedance matching/feeding unit provides coupling to the signal line.

3. The broadband antenna according to claim 2, wherein the signal line comprises:
a first signal part arranged parallel to the second matching member, the second member provides coupling to the first signal part;
a second signal part perpendicular to the second matching member, the impedance matching/feeding unit provides coupling to the second signal part; and
a third signal part electrically connected to the second signal part, the third signal part having a designated length,
wherein the signal line generates dual resonance in high-frequency bands.

4. The broadband antenna according to claim 3, wherein the antenna further comprises:
at least one first protruding part protruding from the first matching member; and
at least one second protruding part protruding from the second matching member,
wherein the first protruding parts and the second protruding parts are separated from one another, and some of the first protruding parts and the second protruding parts are separated by different distances.

5. The broadband antenna according to claim 1, wherein at least one of the first matching member and the second matching member has a bent structure.

6. A broadband antenna comprising:
a substrate;
an impedance matching/feeding unit arranged on the substrate, the impedance matching/feeding unit comprising a first matching member and a second matching member configured to perform impedance matching through a coupling method;
a radiating member electrically connected to the impedance matching/feeding unit; and
a signal line electrically connected to the second matching member,
wherein the signal line further comprises:
a first signal part electrically connected to the second matching member; and
a second signal part electrically connected to the first signal part, the second signal part oriented in a direction that intersects with the second matching member.

7. The broadband antenna according to claim 6, wherein the signal line further comprises a third signal part, the third signal part electrically connected to the second signal part and having a designated length,
wherein the second matching member provides coupling to the first signal part, the impedance matching/feeding part provides coupling to the second signal part, and the signal line has a form of an electrical loop and generates dual resonance in high-frequency bands.

8. The broadband antenna according to claim 6, further comprising:
at least one first protruding part protruding from the first matching member; and
at least one second protruding part protruding from the second matching member,
wherein the first protruding parts and the second protruding parts are separated from one another, and some of the first protruding parts and the second protruding parts are separated by different distances.

9. The broadband antenna according to claim 6, wherein a distance between the first matching member and the second matching member is partially different.

10. The broadband antenna according to claim 6, wherein at least one of the first matching member and the second matching member has a bent structure.

11. The broadband antenna according to claim 6, wherein the radiating member extends from the first matching member, and is fed from the second matching member by a coupling method.
